(19) United States
(12) Patent Application Publication
(10) Pub. No.: US 2012/0217294 A1
(43) Pub. Date: Aug. 30, 2012

(54) MACHINE READABLE CONTACT INFORMATION PLACARD AND READING SYSTEM

(76) Inventor: JACQUELINE E. SOUDERS, Stratford, NJ (US)

(21) Appl. No.: 13/372,762

(22) Filed: Feb. 14, 2012

Related U.S. Application Data
(60) Provisional application No. 61/463,975, filed on Feb. 25, 2011.

(51) Int. Cl. G06F 17/30

(52) U.S. Cl. 235/375

(57) ABSTRACT

A small sign or placard or the like is mounted on the outside of a person's house where it is easily accessible to emergency personnel. Contact or medical information about one or more of the inhabitants is embedded in bar codes or other machine readable form only and is printed or otherwise secured to the placard on the outside thereof. The information would be accessible from the outside but only in machine readable form which can be read by an electronic device carried by the emergency personnel.

### CROSS REFERENCE TO RELATED APPLICATION

This application claims the benefit of Provisional patent application No. 61/463,975, filed Feb. 25, 2011.

### BACKGROUND OF THE INVENTION

The present invention is directed toward a machine readable contact information placard which is intended to be mounted outside of a person's house, apartment or similar residence to provide information to a policeman or fireman or other emergency personnel who may be called to the person's house.

Frequently, a policeman or fireman or other first responder may be called to a person's house because of an emergency or the belief that an emergency situation is in progress. Upon ringing the doorbell or knocking on the door and receiving no response, the emergency responder will not know whether there is, in fact, an emergency situation. He or she must, therefore, make a decision as to whether to break down the door or enter through a window or the like.

Even if the door is open and the emergency responder enters, he or she may find an individual who is unconscious and who will not, therefore, be able to provide information such as contact information, medical information or the like about that person. Such information could be helpful in an emergency situation.

In an effort to solve this dilemma, Applicant previously devised a system that would provide information to the emergency personnel. This product is comprised of a metal or plastic case that can be mounted outside of the person's house or apartment near the door and which contains a piece of paper including contact information and/or other information concerning the residents of the house. The contact information may be, for example, the name and telephone number of a close neighbor or relative who may have a key to the house or may know the whereabouts of the occupants or their family. Other information may include medical information about the residents of the house so as to aid the emergency personnel in providing appropriate treatment. This prior device has been sold by Applicant under the name INCASE.

While the prior INCASE device provides significant benefit, it does suffer from certain inherent deficiencies. Not only can emergency personnel open the INCASE device and learn the contact and other information about the house residents, substantially anyone can do so. This could raise security risks. There is, therefore, the need for a system that can provide needed information to emergency personnel while providing security by maintaining the information secret and unavailable to the public at large.

### SUMMARY OF THE INVENTION

The present invention is designed to overcome the deficiencies of the prior art discussed above. It is an object of the present invention to provide an information placard which is intended to be mounted outside of a person's house and which contains the information in machine readable form.

It is another object of the present invention to provide a machine readable contact information placard which is intended to be mounted outside of a person's house, apartment or similar residence and which will provide information to only a policeman or fireman or other emergency personnel who may be called to the person's house

It is an even further object of the present invention to provide a portable electronic reader adapted to be carried by a policeman or fireman or other emergency personnel that is capable of reading contact information on a placard mounted outside of a person's house, apartment or similar residence to provide human readable information to the emergency personnel

In accordance with illustrative embodiments demonstrating features and advantages of the present invention, there is provided a small sign or placard or the like that can be mounted on the outside of a person's house where it is easily accessible to emergency personnel. Contact information about one or more of the inhabitants is embedded in bar codes or other machine readable form only and is printed or otherwise secured to the placard on the outside thereof. The information would be accessible from the outside but only in machine readable form which can be read by an electronic device carried by the emergency personnel.

Other objects, features and advantages of the invention will be readily apparent from the following detailed description of a preferred embodiment thereof taken in conjunction with the drawings.

### BRIEF DESCRIPTION OF THE DRAWINGS

For the purpose of illustrating the invention, there is shown in the accompanying drawings one form that is presently preferred; it being understood that the invention is not intended to be limited to the precise arrangements and instrumentalities shown.

FIG. 1 is a front perspective view of a placard with machine readable bar code information thereon shown mounted next to the front door of a house, and

FIG. 2 is a schematic representation of an electronic device for reading the machine readable information on the placard and displaying it in human readable form for the emergency personnel.

### DETAILED DESCRIPTION OF THE PREFERRED EMBODIMENT

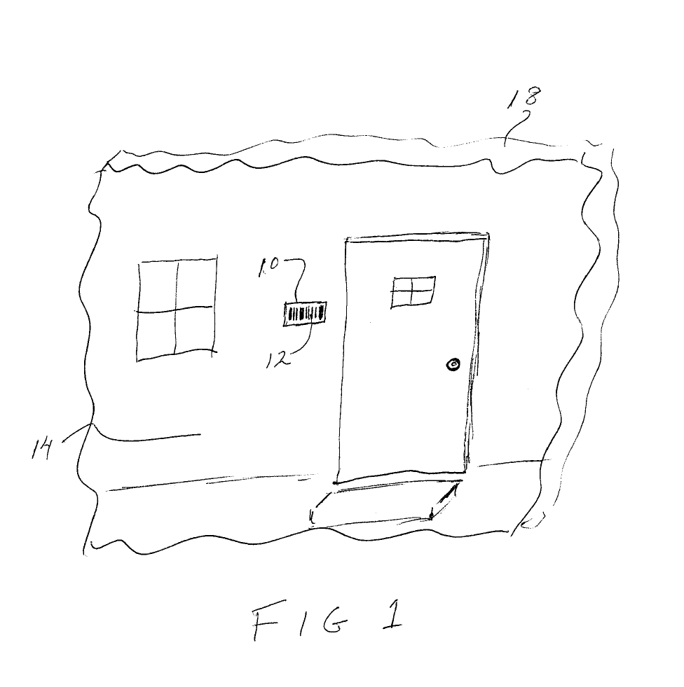

Referring now to the drawings in detail wherein like reference numerals have been used throughout the various figures to designate like elements, there is shown in FIG. 1 a placard 10 with machine readable bar code information 12 thereon shown mounted on a wall 14 next to the front door 16 of a house 18.

The information 12 contained in the bar code may be contact information such as the name and telephone number of a neighbor or relative, the occupants' work or cell numbers and/or medical information about members of the household. Other important information may also be included. The information could, again, be essentially the same as that used with the present INCASE product described above. It is also possible that the bar code contains merely identification information and that the contact or other information specific to the house or apartment in question is stored in a computer data base elsewhere.

In the preferred form of the invention described herein, the information is in the form of a barcode that could be read by a barcode reader. The information could be encrypted so that only authorized personnel having appropriate barcode readers could read the information by scanning the barcode and is not in human readable form. Furthermore, the barcode could be simply printed on paper that could then be laminated and then mounted on the wall or could be permanently printed on some type of plastic material or other weather-resistant material that could be secured to the wall. While the device 10 is being referred to as a placard, this is for convenience only. The device would be in the form of a small sign or plaque or the like that would be mounted to the wall 14 of the house or apartment 18.

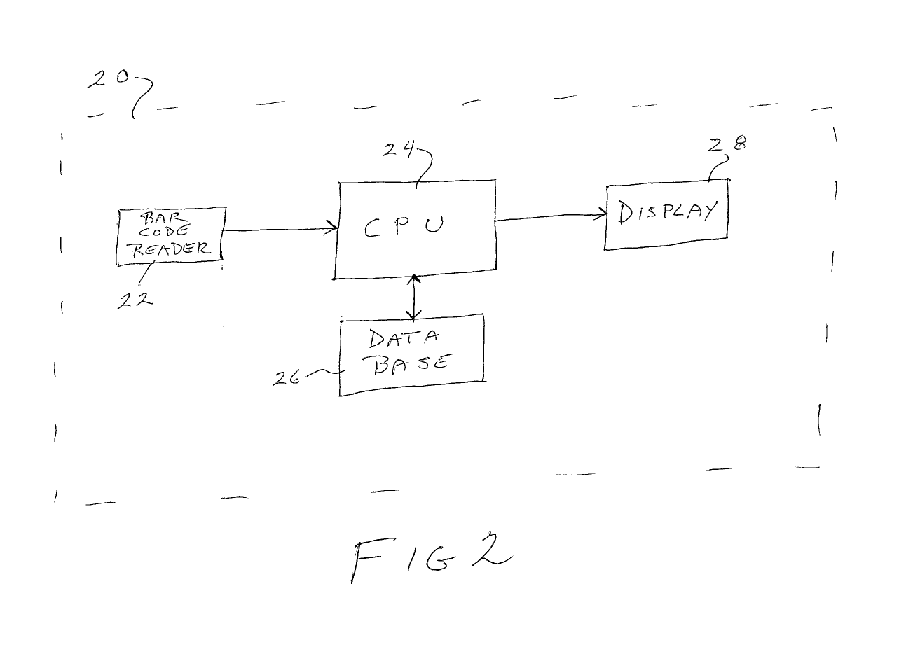

Emergency personnel such as firemen, policemen paramedics or the like will carry with them an electronic device such as shown schematically as 20 in FIG. 2. The device 20 includes a bar code reader or scanner 22 that the emergency personnel passes over the bar code 12. The information is interpreted by the central processing unit (CPU) 24 and is converted into human readable form and displayed to the emergency personnel on display 28.

As pointed out above, the bar code 12 may not contain the actual emergency information but may simply be an address or contain other identifying information. In such a case, the emergency information will be stored in a data base 26 which will be retrieved by the CPU 24. The bar code scanner 22, CPU 24, data base 26 and display 28 or any combination of them, may be contained in a single portable electronic device 20 that can be carried by the emergency responder. It is also possible, however, to design a system were the individual components or some of them are separate and connected by cable or wireless connections. The emergency personnel must, of course, carry the bar code reader 22 with him or her or have the same built into his or her smart phone. The remaining components, however, could be remotely located. Even the display 28 could be located remotely with the information being radioed to the emergency responder. It may also be possible to include numbers along with the bar code that the emergency responder can enter into his or her cell phone or a computer in a police car to view the emergency contact information that is stored on a secured server.

Furthermore, while the use of barcodes is one presently preferred way of providing the machine readable information, it should be readily apparent to those skilled in the art that other types of machine readable codes could also be used. These could be, for example, dot codes or radio frequency (rf) tags or substantially any other type of computer or machine readable information. All that is required would be that the emergency personnel possess a device that is capable of reading the information quickly without having to open any type of container or the like. The information should be readily readable simply by the emergency personnel bringing his or her complementary device in the vicinity of the placard or sign having the machine readable information therein or thereon.

The invention described above is particularly useful in connection with vacant homes, businesses and vacation or second homes. The invention allows first responders to easily access owners regarding any emergency situations at the property for situations such as break-ins, hot water leaks, storm damage or the like. That is, the invention allows first responders to be able to contact the owners of anyone closely related to the property that has the bar code on it.

The present invention may be embodied in other specific forms without departing from the spirit or essential attributes thereof and accordingly, reference should be made to the appended claims rather than to the foregoing specification as indicating the scope of the invention.

I claim:

1. A machine readable contact information placard and reading system comprising:
a placard with personal information contained thereon in machine only readable form;
said placard being mounted on a wall outside of a person's front door;
a portable electronic device carried by an emergency responder, said device including a scanner for reading the machine readable information and including means for displaying the information to the emergency responder in human readable form.
